(19) United States
(12) Patent Application Publication
(10) Pub. No.: US 2016/0171536 A1
(43) Pub. Date: Jun. 16, 2016

(54) SYSTEM AND METHOD FOR PREDICTING FUTURE PURCHASES

(71) Applicant: American Express Travel Related Services Company, Inc., New York, NY (US)

(72) Inventors: Pankaj Garg, Bangalore (IN); Sachin Garg, Bangalore (IN); Subhajit Sanyal, Bangalore (IN)

(73) Assignee: American Express Travel Related Services Company, Inc., New York, NY (US)

(21) Appl. No.: 14/572,374

(22) Filed: Dec. 16, 2014

(51) Int. Cl. G06Q 30/02

(52) U.S. Cl. CPC G06Q 30/0255

(57) ABSTRACT

The system may receive an individual transaction record of a purchase at a merchant location. The individual transaction record may be collected at a point of sale. The individual transaction record may also include at least one of a first purchase time, a first purchase location, a first purchase amount, a first merchant category, or a first purchase item. The system may further predict a future purchase based on the individual transaction record and transmit an offer based on the future purchase.

### FIELD

The present disclosure relates to effective advertisement delivery based on predicted future purchases.

### BACKGROUND

In the online world, customer buying patterns and browsing patterns may be mined while the customer is using a web browser or shopping online. The information collected from the customer may provide insight into whether a particular offer is likely be effective for the customer. Timing the delivery of an offer may further influence the efficacy of the offer. Offers provided through a web browser, for example, may be most effective while the customer is actively shopping online. However, techniques used in web browsing may not be applicable or effective when a customer is shopping at brick and mortar stores.

### SUMMARY

A system, method, and computer readable medium (collectively, the “system”) is disclosed for creating contextual offers based on predicted future purchases. The system may be configured to perform operations and/or steps comprising receiving, by a server, an individual transaction record of a purchase at a merchant location. The individual transaction record may be collected at a point of sale, and the individual transaction record may include at least one of a first purchase time, a first purchase location, a first purchase amount, a first merchant category, or a first purchase item. The system also comprises predicting, by the server, a future purchase based on the individual transaction record and transmitting an offer based on the future purchase.

In various embodiments, the system may comprise receiving, by the server, a second individual transaction record, wherein the second individual transaction record comprises at least one of a second purchase time, a second purchase location, a second purchase amount, a second merchant category, or a second purchase item. Predicting the future purchase may be based on the second individual transaction record. Predicting the future purchase may further be based on a purchase history. Predicting the future purchase may also be based on customer information. The future purchase may include a next merchant category and/or a next spend amount. Various embodiments of the system may also comprise selecting, by the server, the offer in response to a bid.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 illustrates an exemplary system for delivering an offer in response to a predicted future purchase, in accordance with various embodiments;

FIG. 2 illustrates an exemplary system for predicting a future purchase based on an individual transaction record and delivering an offer in response to the predicted future purchase, in accordance with various embodiments;

FIG. 3 illustrates a method for delivering an offer in response to a predicted future purchase, in accordance with various embodiments;

FIG. 4 illustrates a system for selecting an offer in response to a predicted future purchase, in accordance with various embodiments; and

FIG. 5 illustrates a method for selecting an offer in response to a predicted future purchase, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

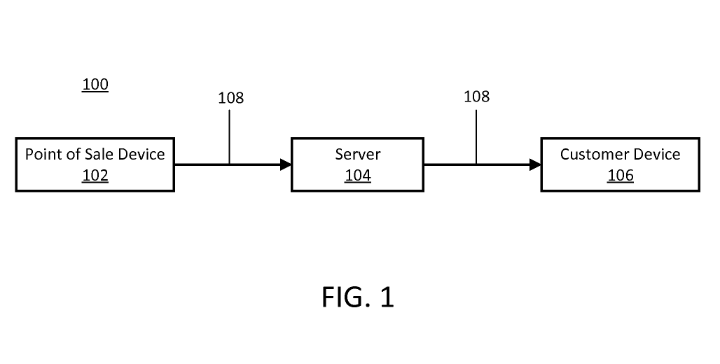

In various embodiments, and with reference to FIG. 1, system 100 may be capable of predicting future purchases of customers and delivering contextual offers related to the future purchases. System 100 may comprise one or more point of sale device 102. Point of sale device 102 may be located at a physical merchant store. Point of sale device 102 may collect transaction information in response to customers making purchases at the physical merchant store. Transaction information may include, for example, a spend amount, merchant category, merchant name, store location, items purchased, purchase time, and/or past transaction information. Point of sale devices 102 may be present at various store locations maintained by various merchants. Thus, point of sale devices 102 may collect transaction information from separate purchases by the customer at different locations.

In various embodiments, system 100 may further comprise a server 104. Server 104 may comprise one or more computer systems in communication with point of sale devices 102 over a network 108. Point of sale devices 102 may send transaction information collected during sales through the network 108 to server 104. Server 104 may be maintained, for example, by a financial institution and/or transaction account provider. Point of sale devices 102 may contact server 104 maintained by the transaction account provider to authorize a transaction on a transaction account. During the authorization, transaction information may be transmitted to server 104. Server 104 may use transaction information to authorize the transaction and to predict future purchases by the customer completing the transaction.

In various embodiments, server 104 may be hosted, for example, by a transaction account provider. Phrases and terms similar to “transaction account” may include any account that may be used to facilitate a financial transaction. Phrases and terms similar to “financial institution” or “transaction account provider” may be used interchangeably and include any entity that offers transaction account services (e.g., payment processor). Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

In various embodiments, system 100 may further comprise customer device 106. Customer device 106 may comprise any device capable of receiving and displaying an electronic message from server 104. For example, customer device 106 may take the form of a computer or processor, or a set of computers/processors, although other types of computing units or systems may be used, including laptops, notebooks, hand held computers, personal digital assistants, cellular phones, smart phones (e.g., iPhone®, BlackBerry®, Droid®, etc.) tablets, wearables (e.g., smart watches and smart glasses), or any other device capable of receiving data over network 108. Customer device 106 may receive offers from server 104 specifically tailored to a customer based on their customer information, transaction history, and/or individual transaction records.

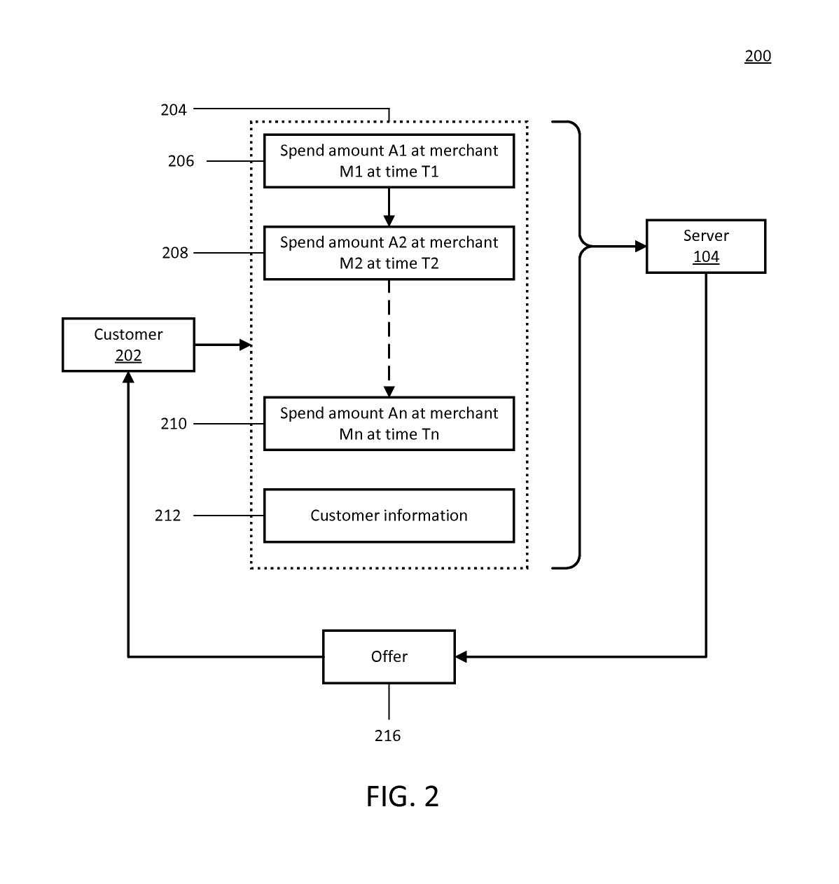

In various embodiments, and with reference to FIG. 2, system 200 for communicating offers to customers is provided. Customer 202 may communicate using customer device 106 from FIG. 1. Customer 202 may opt into a program provided by a transaction account provider to provide transaction information 204. Transaction information 204 may comprise customer information 212. Customer 202 may provide customer information 212 (e.g., merchants of interest, gender, age, or other information for use in projecting future purchases by customer 202). Transaction information 204 for customer 202 may be captured and transmitted by point of sale device 102 of FIG. 1 to server 104.

Transaction information 204 may include individual transaction records 206-210. As used herein, each individual transaction record 206-210 may include one, multiple, all or any subset of transaction records, and/or any aggregate data among many records, any portion of the data within a record or all of the data within a transaction record. A first individual transaction record 206 may include a spend amount A1, a merchant location M1, and a time T1. Spend amount A1 may be the amount of a purchase made by customer 202 at merchant location M1 and at time T1. A second individual transaction record 208 may include a spend amount A2, a merchant location M2, and a time T2. Spend amount A2 may be the amount of a purchase made by customer 202 at merchant location M2 and at time T2. Subsequent individual transaction records may include similar information up to an Nth individual transaction record. The Nth individual transaction record 210 may be the most recent individual transaction record for customer 202 and may include a spend amount An, a merchant location Mn, and a time Tn. For example, first individual transaction record 206 may be generated in response to customer 202 purchasing a shirt at merchant M1 for amount A1 of $50.00 at time T1 of 5:00 pm on Oct. 10, 2010. Customer 202 may then purchase pants at merchant M2 for amount A2 of $50.00 at time T2 of 5:30 pm on Oct. 10, 2010 and thereby generate second individual transaction record 208.

In various embodiments, individual transaction records 206-210 may comprise a record of charge (or “ROC”) comprising transaction data. The ROC may include a unique identifier associated with a transaction. A transaction may, in various embodiments, be performed by a one or more customers using a transaction account, such as a transaction account associated with a gift card, a debit card, a credit card, and the like. A ROC may, in addition, contain details such as location, merchant name or identifier, transaction amount, transaction date, account number, account security pin or code, account expiry date, and the like for the transaction. The server may obtain typical ROC data that is sent with each authorization/transaction. The server may also obtain additional data based on a request from the server, the POS programmed to send extra data, in response to other triggers, etc.

In various embodiments, each individual transaction record 206-210 (or any subset) may be transmitted to server 104, in response to customer 202 completing a transaction that generates an individual transaction record. The data may also be obtained in batch, periodically, at certain times, etc. Server 104 may store and/or use each individual transaction record 206-210 in response to receiving the individual transaction records. Server 104 may also store and/or use customer information 212 that was obtained prior to or contemporaneously with individual transaction records. Customer information 112 may include internal data, external data, data obtained from any channel, etc. Server 104 may store individual transaction records 206-210 and customer information 212 in a database, for example. Server 104 may use individual transaction records 206-210 and customer information 212 to predict a future purchase by customer 202.

Continuing the above example, server 104 may review the transaction history of customer 202 and predict that customer 202 makes a purchase at a third marchant 60% of the time that customer 202 makes purchases at both merchant M1 and merchant M2 on the same day. Server 104 may thus predict that customer 202 is likely to make a purchase at the third merchant on Oct. 10, 2010 in response to receiving the first and second individual transaction records. Server 104 may then send an offer 216 to customer 202 via customer device 106 from FIG. 1 (e.g., as a push notification, pop up notification, text message, or email).

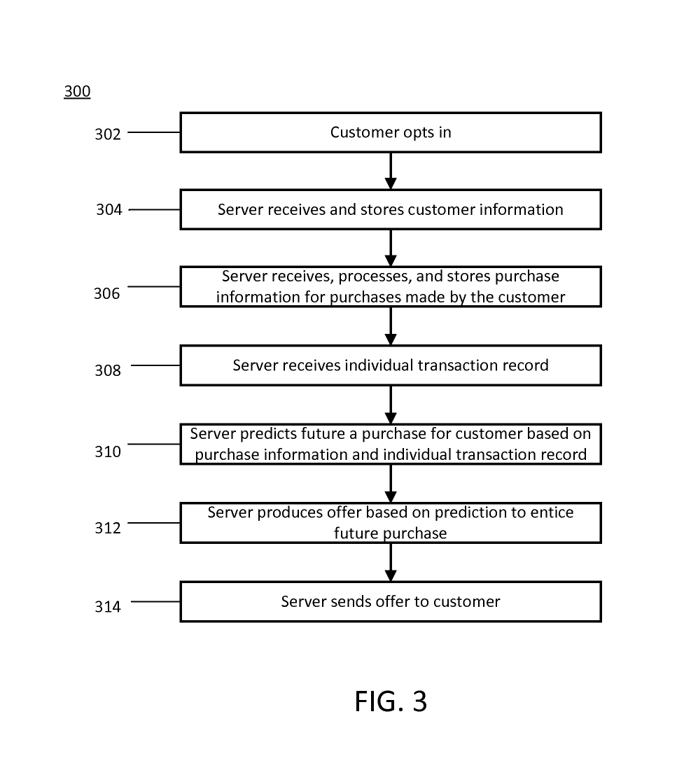

In various embodiments, and with reference to FIG. 3, system 100 may be capable of performing operations and/or steps of method 300 for predicting future customer purchases. A customer may opt in to the predictive offer program (Step 302). Server 104 may receive and store customer information 212 (Step 304). For example, customer 202 may provide customer information 212 to server 104 while opting in. Customer 202 may also provide customer information 212 at a merchant location and the merchant may relay customer information 212 to server 104.

In various embodiments, server 104 may receive, process, and/or store purchase information for purchases made by customer 202 (Step 306). Server 104 may receive individual transaction records 206-210 from merchants as customer 202 makes purchases. The purchases may be spread over a variety of locations and over varied times. Server 104 may process and store individual transaction records 206-210 to project future purchases of customer 202. Thus, server 104 may store past purchase information based on the individual transaction records of the purchases of customer 202. Using the past purchase information, server 104 may make a model or otherwise project future purchase behavior of customer 202 from the historic record of individual transaction records. Server 104 may receive at least one of individual transaction records 206-210 (Step 308). The received individual transaction record may indicate that customer 202 made a recent purchase.

In various embodiments, server 104 may predict a future purchase for customer 202 based on purchase information and individual transaction record 210 (Step 310). For example, server 104 may have past purchase information for customer 202 indicating that customer 202 made ten separate purchases at a food court each following a purchase made in a shopping mall. Thus, past purchase information may suggest that customer 202 is likely to make a purchase at the food court following a purchase in the shopping mall. Server 104 may receive an individual transaction record in response to customer 202 making a purchase at the shopping mall. Thus, server 104 may project that customer 202 is likely to make a purchase in the food court as a result. Continuing the above example, server 104 may project that customer 202 is likely to visit one of five merchants in the food court. An offer 216 valid at one of the five merchants may entice the customer to make a purchase at the merchant making offer 216 rather than one of the other five merchants.

In various embodiments, server 104 may produce offer 216 based on a prediction to entice the future purchase (Step 312). Continuing the above example, server 104 may produce offer 216 specifically chosen for customer 202 to be redeemed at one of the five merchants in the food court. The offer may be tailored to customer 202 on the current shopping trip. In that regard, the offer may be limited in duration and geographic location. Continuing with the present example, the offer may be valid for the next three hours at the merchant location in the food court. Server 104 may send the offer to customer 202 (Step 314). Method 300 enables merchants to provide offers to customer 202 in the context of the real world shopping habits of customer 202.

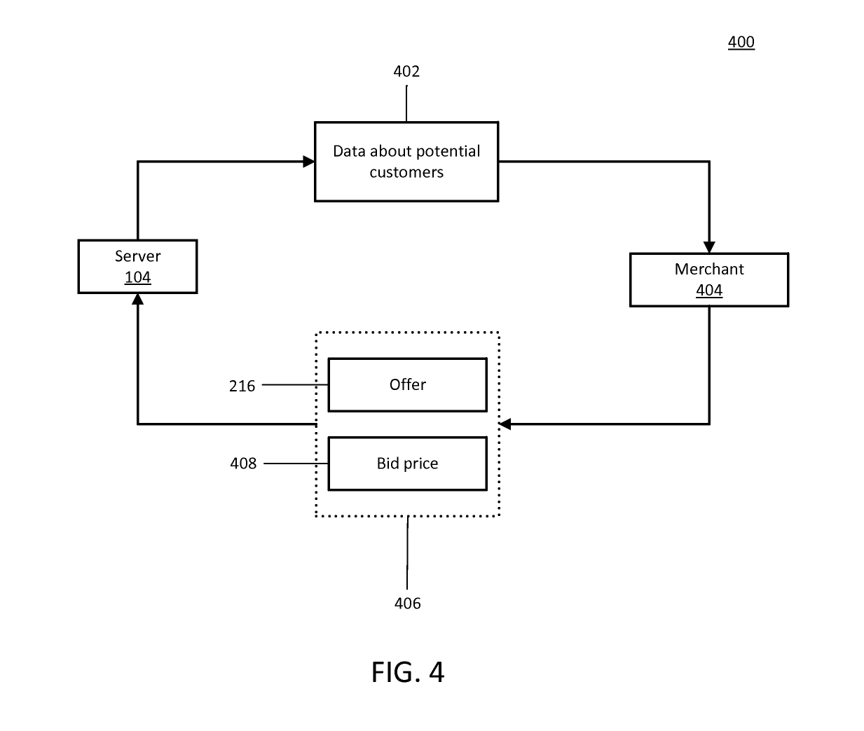

In various embodiments, and with reference to FIG. 4, system 400 may integrate with system 100 of FIG. 1 to enable server 104 to accept bids 406 from merchant 404. Server 104 may provide data 402 about potential customers to merchant 404. Data about customer 402 may include, for example, potential purchase category, potential purchase item, potential purchase amount, potential purchase time, potential purchase quantity, potential purchase, customer demographic information (e.g., age or gender) and/or other data to identify predicted customer purchases. Merchant 404 may submit bid 406 to server 104. Bid 406 may comprise bid price 408 and offer 216. Bid price 408 may be an amount that merchant 404 will pay each time its offer 216 is submitted to customer 202 of system 200 in FIG. 2. Offer 216 may contain a discount or promotion for merchant 404. Server 104 may select bid 406 as a winning bid and send offer 216 of bid 406 to customer 202, as shown in step 314 of FIG. 3.

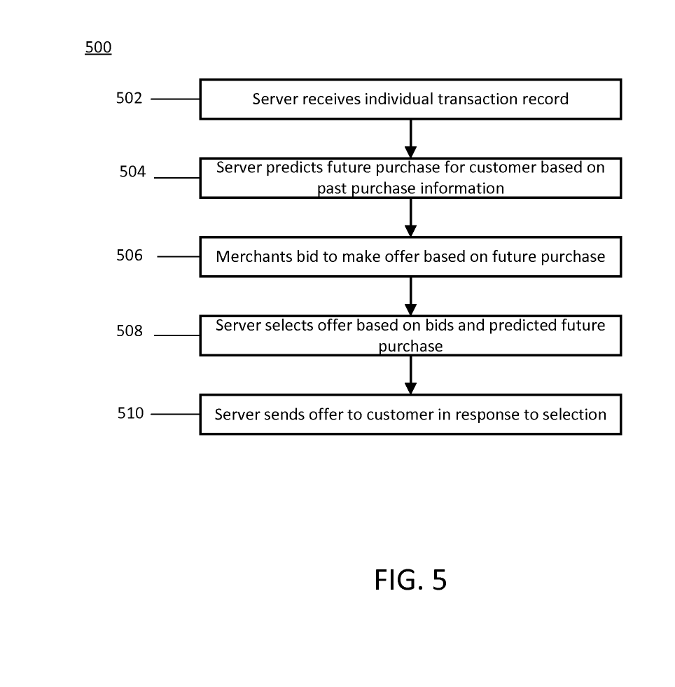

In various embodiments, and with reference to FIG. 5, system 100 may be capable of performing operations and/or steps of method 500 for accepting bids to provide an offer to customer 202 for a predicted purchase. Server 104 may receive individual transaction record 210 (Step 502). Server 104 may predict a future purchase for customer 202 based on purchase information and individual transaction record 210 (Step 504). Steps 502 and 504 may be similar to those of method 300 and other steps of method 300 may be included in method 500. Merchants may submit a bid to provide offer 216 based on the future purchase (Step 506). Merchant bids may include a bid price and details regarding the potential future customers the merchant may be bidding on.

For example, a merchant MA may bid to make an offer when server 104 predicts that customer 202 is likely to make any type of clothing purchase within a mile radius. Customer 202 may purchase a shirt at merchant M1 for amount A1 of $50.00 at time T1 of 5:00 pm on Oct. 10, 2010 and thereby generate first individual transaction record 206. Customer 202 may then purchase pants at merchant M2 for amount A2 of $50.00 at time T2 of 5:30 pm on Oct. 10, 2010 and thereby generate second individual transaction record 208. In response to receiving second individual transaction record 208, server 104 may predict that customer 202 is likely to make a clothing purchase within a mile of merchant M2 by 8:00 pm on Oct. 10, 2010.

In various embodiments, merchants may submit bids to provide offer 216 to customer 202 in response to server 104 receiving second individual transaction record 208 matching one or more parameters and the customer information 212 of customer 202. Continuing the above example, merchant MA may bid to provide offer 216 in response to server 104 predicting customer 202 will make a clothing purchase. Merchant MB may bid to provide offer 216 in response to server 104 predicting customer 202 will make any purchase within a mile of merchant MB. Merchant MC may bid to provide offer 216 in response to server 104 predicting customer 202 will make any purchase within a day of server 104 receiving any individual transaction record 206-210. Merchant MD may bid to provide offer 216 in response to server 104 predicting customer 202 will make a clothing purchase within a mile of merchant MD. Merchant ME may bid to provide offer 216 in response to server 104 predicting customer 202 will make a clothing purchase within a half hour of server 104 receiving any individual transaction record 206-210.

In various embodiments, server 104 may select offer 216 based on bids and the predicted future purchase (Step 508). Continuing the above example, merchants MA, MB, and MC may have submitted bids with parameters matching the predicted future purchase in response to second individual transaction record 208. Server 104 may select offer 216 corresponding to the highest bid from the qualifying bids of merchants MA, MB, and MC. Server 104 may send the offer 216 to customer 202 in response to selecting offer 216 (Step 510).

Thus, the systems and methods herein enable merchant 404 to provide customers 202 with offers 216 in improved context while customer 202 is shopping at brick and mortar stores. Offers 216 may be made without mining context from customer 202 shopping or browsing the web on customer device 106. In that regard, customer 202 may receive offer 216 at a time when offer 216 is highly beneficial to customer 202. Similarly, merchant 404 may make offer 216 when customer 202 is likely receptive to offer 216.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTube®, AppleTV®, Pandora®, xBox®, Sony® Playstation®), a uniform resource locator (“URL”), a document (e.g., a Microsoft Word® document, a Microsoft Excel® document, an Adobe .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile,” “customer data,” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT®, Windows 95/98/2000®, Windows XP®, Windows Vista®, Windows 7®, OS2, UNIX®, Linux®, Solaris®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, components, modules, and/or engines of system 100 may be implemented as micro-applications or micro-apps. Micro-apps are typically deployed in the context of a mobile operating system, including for example, a Palm® mobile operating system, a Windows® mobile operating system, an Android® Operating System, Apple® iOS, a Blackberry® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “offer” may include any good, service, information, experience, entertainment, data, item, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by an offer server, an individual transaction record;
wherein the individual transaction record is collected at a point of sale,
wherein the individual transaction record comprises at least one of a first purchase time, a first purchase location, a first purchase amount, a first merchant category, or a first purchase item;
predicting, by the offer server, a future purchase based on the individual transaction record; and
transmitting, by the offer server, an offer based on the future purchase.

2. The method of claim 1, further comprising receiving, by the offer server, a second individual transaction record, wherein the second individual transaction record comprises at least one of a second purchase time, a second purchase location, a second purchase amount, a second merchant category, or a second purchase item.

3. The method of claim 2, wherein the predicting the future purchase, by the offer server, is further based on the second individual transaction record.

4. The method of claim 1, wherein the predicting the future purchase, by the offer server, is further based on a transaction history.

5. The method of claim 1, wherein the predicting the future purchase, by the offer server, is further based on customer information.

6. The method of claim 1, wherein the predicting the future purchase, by the offer server, further comprises at least one of predicting a next merchant category or predicting a next spend amount.

7. The method of claim 1, further comprising selecting, by the offer server, the offer in response to a bid.

8. A computer-based system, comprising:
an offer processor;
a non-transitory memory configured to communicate with the offer processor, the non-transitory memory having instructions stored thereon that when executed by the offer processor cause the computer-based system to perform operations comprising:
receiving, by the offer processor, an individual transaction record;
wherein the individual transaction record is collected at a point of sale,
wherein the individual transaction record comprises at least one of a first purchase time, a first purchase location, a first purchase amount, a first merchant category, or a first purchase item;
predicting, by the offer processor, a future purchase based on the individual transaction record; and
transmitting, by the offer processor, an offer based on the future purchase.

9. The computer-based system of claim 8, further comprising receiving, by the offer processor, a second individual transaction record, wherein the second individual transaction record comprises at least one of a second purchase time, a second purchase location, a second purchase amount, a second merchant category, or a second purchase item.

10. The computer-based system of claim 9, wherein the predicting the future purchase, by the offer processor, is further based on the second individual transaction record.

11. The computer-based system of claim 8, wherein the predicting the future purchase, by the offer processor, is further based on a transaction history.

12. The computer-based system of claim 8, wherein the predicting the future purchase, by the offer processor, is further based on customer information.

13. The computer-based system of claim 8, wherein the predicting, by the offer processor, the future purchase further comprises at least one of predicting a next merchant category or predicting a next spend amount.

14. The computer-based system of claim 8, further comprising selecting, by the offer processor, the offer in response to a bid.

15. A non-transitory computer program product having computer-executable instructions stored thereon that, if executed by a computer based offer system, causes the computer based offer system to be capable of performing operations comprising:
receiving, by the computer based offer system, an individual transaction record;
wherein the individual transaction record is collected at a point of sale,
wherein the individual transaction record comprises at least one of a first purchase time, a first purchase location, a first purchase amount, a first merchant category, or a first purchase item;
predicting, by the computer based offer system, a future purchase based on the individual transaction record; and
transmitting, by the computer based offer system, an offer based on the future purchase.

16. The computer program product of claim 15, further comprising receiving, by the computer based offer system, a second individual transaction record, wherein the second individual transaction record comprises at least one of a second purchase time, a second purchase location, a second purchase amount, a second merchant category, or a second purchase item.

17. The computer program product of claim 16, wherein the predicting the future purchase, by the computer based offer system, is further based on the second individual transaction record.

18. The computer program product of claim 15, wherein the predicting the future purchase, by the computer based offer system, is further based on a transaction history.

19. The computer program product of claim 15, further comprising selecting, by the computer based offer system, the offer in response to a bid.

20. The computer program product of claim 15, wherein the predicting, by the computer based offer system, the future purchase further comprises at least one of predicting a next merchant category or predicting a next spend amount.
